(19) United States
(12) Patent Application Publication
(10) Pub. No.: US 2006/0167603 A1
(43) Pub. Date: Jul. 27, 2006

(54) Method and device for controlling occupant protection means in a vehicle

(75) Inventors: Jurgen Brandl, Kanagawa (JP); Helge Grasshoff, Regensburg (DE); Dieter Kloss, Shanghai (CN); Serigne Lo, Auburn Hill, MI (US); Akinori Watanabe, Regensburg (DE)

Correspondence Address: LERNER GREENBERG STEMER LLP, P O BOX 2480, HOLLYWOOD, FL, 33022-2480, US

(73) Assignee: Siemens Aktiengesellschaft

(21) Appl. No.: 10/544,960

(22) PCT Filed: Feb. 6, 2004
(86) PCT No.: PCT/EP04/01123

§ 371 Date: Aug. 8, 2005

(30) Foreign Application Priority Data
Feb. 7, 2003 (DE) 103 05 087.6

(51) Int. Cl. B60R 22/00

(52) U.S. Cl. 701/45; 701/46

(57) ABSTRACT

The invention relates to a method and a device for controlling occupant protection means in a vehicle. According to said method, a first crash variable (AAA), derived from the absolute value for the crash signal of a crash sensor, preferably from the acceleration signal of an acceleration sensor, is compared with a first firing threshold (th1a, th1b, th1c). In addition, a second crash variable (wj, wv, ws), derived in a different manner from the crash signal (a) of the crash sensor (1) is compared with a second firing threshold (th2a, th2b, th2c). The occupant protection means is only fired if the first crash variable (AAA) exceeds the first firing threshold value (th1a, th1b, th1c) and simultaneously the second crash variable (wj, wv, ws) exceeds the second firing threshold (th2a, th2b, th2c).

The invention relates to a method and a device for controlling occupant protection means in a motor vehicle. This involves comparing a first crash variable derived from the crash signal of a crash sensor, preferably from the acceleration signal of an acceleration sensor, with a first firing threshold. In addition a second crash variable derived in another way from the crash signal of the crash sensor is compared with a second firing threshold. The occupant protection means of the vehicle is only fired if both the first firing threshold is exceeded by the first crash variable and the second firing threshold by the second crash variable.

A device for activating a fireable occupant restraint means (28) through a firing signal (120) is known from U.S. Pat. No. 5,935,182. The firing signal (120) is output if both a pre-displacement signal (40) obtained from an acceleration signal (40) of an acceleration (22) through double integration exceeds an associated threshold value (82) and additionally a speed signal (\dot{x}, 72) obtained by single integration from the acceleration signal (40) exceeds an associated threshold value (92).

Usually for example acceleration sensors for detection of frontal or also side impacts of a motor vehicle are arranged in a central control unit which is mostly attached to the transmission tunnel and is thereby very close to the vehicle occupants. The acceleration sensor is therefore subject to approximately the same accelerations which affect the vehicle occupants.

In the event of a road traffic accident however positive and negative accelerations generally occur at the location of the acceleration sensor which are partly caused by the force operating to accelerate the entire motor vehicle but on the other hand are also caused by high-frequency vibrations through deformation of the vehicle bodywork, for example sound vibrations in the vehicle chassis. The high-frequency vibrations caused by material deformations during a road traffic accident however generally have little effect on the severity of the injuries to a vehicle occupant, which is why an acceleration signal of an acceleration sensor is mostly lowpass filtered by a suitable algorithm before its actual evaluation. The lowpass-filtered acceleration signal however also continues to consist of an oscillating signal with positive and negative signal amplitudes, with the negative signal amplitudes mostly being caused by the deceleration operating on the motor vehicle as a whole by the crash and the positive signal amplitudes by elastic and inelastic deformations of the vehicle bodywork, for example the crumple zone, etc. For an acceleration sensor fitted turned through 180 degrees the leading signs of the signal amplitudes are reversed accordingly.

The amplitudes of both the leading signs in the lowpass-filtered acceleration signal produce lower amplitudes on average of the subsequent differently integrated acceleration signals, for which the integrated values are to be compared with suitable threshold values, for example the integrated and double integrated signals derived from the acceleration signal (40) of the acceleration sensor (22) of U.S. Pat. No. 5,935,182 (\dot{x}, x). Therefore the corresponding appropriate low threshold values (80, 92) must also be selected, which reduces the safety of the device in relation to incorrect firing, since even relatively small, less oscillating accelerations can lead to firing of the occupant protection means. Such accelerations occur for example when a motor vehicle knocks against a curb stone or also when driving over uneven cobbled streets.

The object of the present invention is to design the activation of an occupant protection means in a motor vehicle on the basis of different crash variables derived from a crash signal of a crash sensor by suitable selection of the crash variables to make it as secure as possible against misfiring.

In this document an acceleration sensor and an accompanying acceleration signal are repeatedly referred to as the crash sensor and as crash signal but this should not be misunderstood as a restriction on the general expression crash sensor or crash signal. Another type of sensor can also serve as a crash sensor, for example a pressure sensor, which is able to output a corresponding pressure signal or a deflection sensor which captures the deformations of vehicle components, and so forth.

The object is achieved by a method with the features in accordance with claim 1. The object is further achieved by a device for controlling an occupant protection means in a motor vehicle with the features in accordance with claim 7.

The method in accordance with the invention uses as its first crash variable the absolute amount of a crash signal of a crash sensor, preferably of an acceleration signal of an acceleration sensor in accordance with the preamble of claim 1. The value of an integral subsequently formed from the acceleration signal over time is thereby increased on average, which means that a higher threshold value for the first crash variable arising from the absolute amount of the acceleration signal can be selected and thereby misfiring rendered more difficult. A further advantage of using a first crash variable formed from the absolute value of an acceleration signal is also that for the subsequent integral formation the signal components oscillating in the negative signal range of the acceleration sensor contribute with the leading sign removed along with the positive acceleration signals to the value of the integral, so that this value increases significantly more quickly than with a merely lowpass-filtered signed acceleration signal. This means that where necessary a significantly faster firing decision can be obtained.

For the integral formation of the absolute amount of the acceleration signal it is mostly necessary to ensure that a suitable normalization factor is taken into account in the calculation formula for the integral, so that the time integral does not assume unphysically high values over the course of time as a result of the computing operation selected. To calculate the integrals of the absolute amount of the crash signal the following formula can therefore advantageously be selected:

$$AAA ( {T}_{1} , {T}_{2} ) = \frac{1}{{T}_{2} - {T}_{1}} {\int }_{{T}_{1}}^{{T}_{2}} \vert a ( t ) \vert ⅆ t , \qquad ( 1 a )$$

where AAA designates the first crash variable and T₁ and T₂ define the beginning or the end of the integration of the amount of the acceleration a depending on the time t.

It is further of advantage also to subject the absolute amount of the acceleration signal to lowpass filtering since also in the purely positive area signal oscillations can be caused for example by high-frequency sound oscillations in the deformed vehicle material which can adversely effect the meaningful evaluation of the crash signal. Bandpass filtering can also be provided as an alternative. It goes without saying that such lowpass or bandpass filtering can also be undertaken even before the formation of the absolute amount of the acceleration signal, if necessary the relevant signal is filtered both before and after its integration.

Since the integration is mostly undertaken in microcontrollers nowadays, the calculation of Integral values must usually be replaced by a corresponding summation, preferably in accordance with the following formula:

$$AAA ( {t}_{n} , b ) = \frac{1}{b} {\sum }_{i = n - b}^{n} \vert {a}_{i} ( {t}_{i} ) \vert \cdot 1 ms \qquad ( 1 )$$

where tₙ designates the time of the determination of the first crash variable AAA and b+1 the number of the sum terms calculated for the individually unsigned acceleration values aᵢ, i for the sum index of the summation of i=n−\dot{b} to n and ms for the physical unit milliseconds which is merely shown here however for the sake of the physical correctness of the formula. The formula (1) is actually calculated within a microontroller generally without the use of units and in the time intervals which an internal clock signal specifies for the individual computing steps in the microontroller. To this extent the above formula (1) applies for a computing clock signal with a clock frequency of one Kilohertz. This nomenclature is to be retained in the remainder of this document.

In order to perform the lowpass filtering referred to above after the integral computation performed in this way a corresponding suitable digital low pass filtering is advantageously to be undertaken.

The first crash variable formed in this way is checked in a suitable evaluation unit which is usually arranged in the central control unit to see whether it has exceeded a first threshold value. Only if this first threshold value is exceeded by the first crash variable, and a second threshold value is also exceeded by a second crash variable is an occupant protection means activated accordingly. The activation of the occupant protection means here in the simplest case an activation for immediate firing of the occupant protection means for example of an airbag. If necessary the occupant protection means however is not fired immediately solely as a result of the first and second firing threshold being exceed by the first or second crash variable. Usually other additional activation criteria are taken into account as well. On the one hand this can be the exceeding of what is known as a safing threshold by the signal of a safing sensor already known from U.S. Pat. No. 6,036,225. Further additional activation criteria can also be signals from crash sensor units positioned outside the centrally arranged occupant protection unit. These can for example be what are known as pressure satellites in the front or the rear vehicle doors which, as a firing decision sensor signal, can notify the central control unit of an increase in pressure in the surrounding side door in each case, but also acceleration sensors correspondingly arranged on the sides of the motor vehicle, which can notify sideways accelerations to the central control unit, or also acceleration/ or pressure sensor units outside the central control unit arranged either in the trunk or in the engine compartment of the motor vehicle and supplying acceleration signals or pressure signals to the central control from there.

The crash signal of the same crash sensor is used in accordance with the invention to provide a second crash variable in addition to the first crash variable already described which may make the firing decision, with the second crash variable however being derived in a different way from the first crash variable.

Advantageously the sum of a number of difference terms of two chronologically consecutive digital values of the first crash variable is formed as the second crash variable in accordance with the following formula:

$$wj ( {t}_{n} , b ) = {\sum }_{i = n - b}^{n} ( {AAA}_{i} ( {t}_{i} , b ) - {AAA}_{i - 1} ( {t}_{i - 1} , b ) ) . \qquad ( 2 )$$

The second crash variable wj calculated in this way thus reflects a change to the average acceleration amount operating on the vehicle occupants during a limited period of observation t_{n-b-1}−tₙ₋₁. Consequently the crash variable wj provides a measure for the force acting on a vehicle occupant during of the observation period for further evaluation of the road traffic accident.

As a further second crash variable to be used advantageously however, a value wv integrated directly from the crash signal of the crash sensor over a limited period can be used:

$$wv ( {T}_{1} , {T}_{2} ) = {\int }_{{T}_{1}}^{{T}_{2}} a ( t ) ⅆ t \qquad ( 3 a )$$

The second crash variable wv determined in this way therefore involves a speed value in the observation interval of T₁ to T₂.

For calculation in a microcontroller normally used nowadays, instead of the integral, a sliding sum of consecutive chronological digital values aᵢ of the crash signal is calculated and the following formula is used to do this:

$$wv ( {t}_{n} , b ) = {\sum }_{i = n - b}^{n} {a}_{i} ( {t}_{i} ) \cdot 1 ms \qquad ( 3 )$$

Furthermore a double integrated value of the (signed, but usually filtered beforehand) acceleration signal can serve as an advantageous second crash variable, where the first integration is performed over the entire period of the capturing of the acceleration signal and the second Integration is only performed over a limited time window, preferably in accordance with the following formula:

$$ws ( {T}_{1} , {T}_{2} ) = {\int }_{{T}_{1}}^{{T}_{2}} Δ v ( t ) ⅆ t = {\int }_{{T}_{1}}^{{T}_{2}} {\int }_{0}^{{T}_{2}} a ( t ) ⅆ t ⅆ t , \qquad ( 4 a )$$

in which case the double integration is again advantageously replaced by a double summation for digital calculation of this integral value in a microcontroller, preferably corresponding to the formula:

$$ws ( {t}_{n} , b ) = {\sum }_{i = n - b}^{n} Δ {v}_{i} ( {t}_{i} ) \cdot 1 ms = {\sum }_{i = n - b}^{n} {\sum }_{i = 0}^{n} {a}_{i} ( {t}_{i} ) \cdot 1 ms \cdot 1 ms \qquad ( 4 )$$

The variable Δv then applies in accordance with the specified formula (4) as a measure for the overall change in speed of the vehicle since the start of operation. the second crash variable ws provides information about the preliminary displacement of a vehicle occupant seen relative to their motor vehicle, which in the course of a road traffic accident is mostly more sharply decelerated than the vehicle occupants. The second crash variable ws formed in this way preferably contributes for example to changing the firing strategy of an occupant protection means.

The inventive device features an acceleration sensor to capture accelerations during a road traffic accident and a number, but at least two, acceleration signal processing units connected to the acceleration sensor for converting the acceleration signal generated by the acceleration sensor into a number, but especially two, crash variables. The signal output of an acceleration signal processing unit is connected in each case to an evaluation unit for evaluation of the crash variables fed to it. The output of a firing signal to a firing unit of the occupant protection means connected to the evaluation unit is undertaken in accordance with the invention only if at least two crash variables exceed a relevant firing threshold. A decisive factor for the inventive device in this case is that the first acceleration signal processing unit features an absolute amount generator to which, on the input side the acceleration signal of the acceleration sensor is fed, and at the signal output of which an absolute amount of the captured acceleration signal is present. This absolute amount is fed to the evaluation unit directly or after a further editing as the first crash variable.

For further editing of the absolute amount of the acceleration signal the absolute amount generator of the first acceleration signal processing unit is advantageously connected downstream from a first integration unit, so that at the signal output of the first acceleration signal editing unit the first crash variable is present which is derived from a time integral of the absolute amount of the crash signal and this is done advantageously in accordance with the summation formula (1) explained above.

To create the second crash variable in the second acceleration signal processing unit it is of advantage for the second acceleration signal processing unit to feature a delay element and further a logical addition/subtraction unit with three signal inputs. A first signal input of the addition/subtraction unit is connected to a signal output of the delay element which delays the first crash variable directly present at its signal input by a time, and usually delays it by the time between two internal computing clock signals of the inventive device. The first crash variable is applied directly to a second signal input of the addition/subtraction unit. The logical addition/subtraction unit generates from the two signals fed to it a difference between two chronologically consecutive digital values of the first crash variable. The signal output of the addition/subtraction unit is fed back to a third signal input of the addition/subtraction unit, of which the consecutive signal values present are added so that after an initial start-up phase of the inventive device, at the signal output of the addition/subtraction unit as a second crash variable, a sum of a number of difference terms of chronologically consecutive digital values of the first crash variable is available in each case, for example corresponding to the above formula (2).

In a advantageous development of the inventive device the second acceleration signal processing unit can however also feature a second integration unit for performing a time integration of its input signal, which on the input side has the acceleration signal applied to it and at its signal output is connected to the signal output of the second acceleration signal processing unit, so that as the output signal of the second acceleration signal processing unit there is a second crash variable embodied as a speed signal available, preferably formed in accordance with the above formula (3).

Alternatively it can continue be of advantage for the second acceleration signal processing unit to feature an integration unit which integrates its input-side fed acceleration signal over the entire period that the acceleration signal its present and in its second step integrates the first integral obtained over a limited time window a second time.

Also of advantage for calculation in a controller in this case is to execute the double integral by a double sum of consecutive digital values of the acceleration signal in accordance with the above formula (4) so that the second crash variable is a measure for the preliminary displacement of the vehicle occupants relative to the vehicle.

At this point it should be pointed out once more that exceeding of a first and second threshold by the first or the second crash variable does not have to absolutely lead to an immediate firing of a suitable occupant protection means. The exceeding of these thresholds can also be used to establish the crash severity of the actual firing of an occupant protection means, which can be taken into account for the further evaluation of this or also of other crash variables. For example it can be of advantage for a further evaluation of various crash variables to take account of the measure of preliminary displacement of the vehicle occupants and only if a further pair consisting of a first and a second threshold is exceeded by a corresponding first and second crash variable to fire the first inflation stage of an airbag so that a vehicle occupant who has been displaced very far forward during the course of the crash is not additionally injured by the rapidly unfolding airbag. On the other hand establishing that a vehicle occupant has only been displaced very slightly during the initial phase of a road traffic accident can for example be used to fire both a first and a second stage as well as possibly a third inflation stage of an airbag. This case occurs for example if a vehicle occupant is already being restrained very greatly by a further occupant protection means, for example a belt tensioner in the initial phase of a road traffic accident and therefore a relatively large extension space must be filled by the airbag between the firing module of the airbag and the vehicle dashboard and the vehicle occupant so that the vehicle occupant can be decelerated as specified by the airbag.

Likewise all available ways of calculating a second crash variable a can also be used simultaneously in combination with the first crash variable to activate a suitable occupant protection means accordingly. Equally, different combinations of the individual differently-determined second crash variables are possible in order to serve accordingly as a firing criterion or as a criterion for adapting the activation strategy of the occupant protection means.

The invention will now be presented with reference to various exemplary embodiments of the inventive method or the inventive device. The Figures show

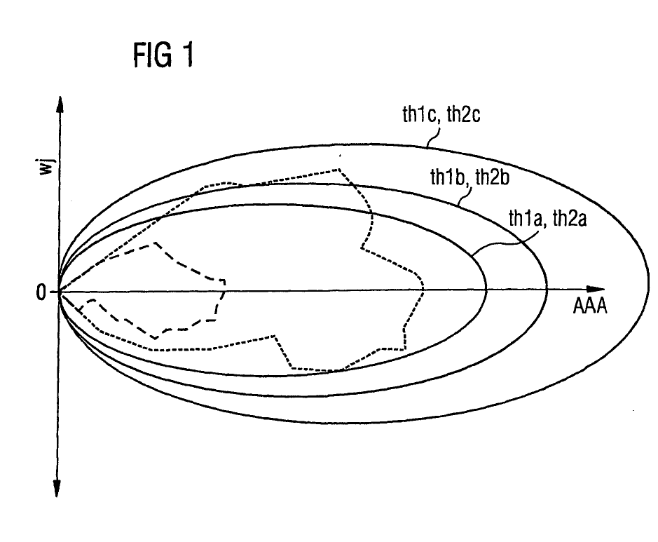

FIG. 1 a schematic plot of a first crash variable AAA against a second crash variable wj for activation of an occupant protection means corresponding to a serious road traffic accident (dotted line) and a minor road traffic accident (dashed line) and, depending on this, shown as a solid line, a curve of first and second threshold values for a first firing stage th1a and th2a, for a second firing stage th1b and th1b and a third firing stage th1c and th2c of an occupant protection means

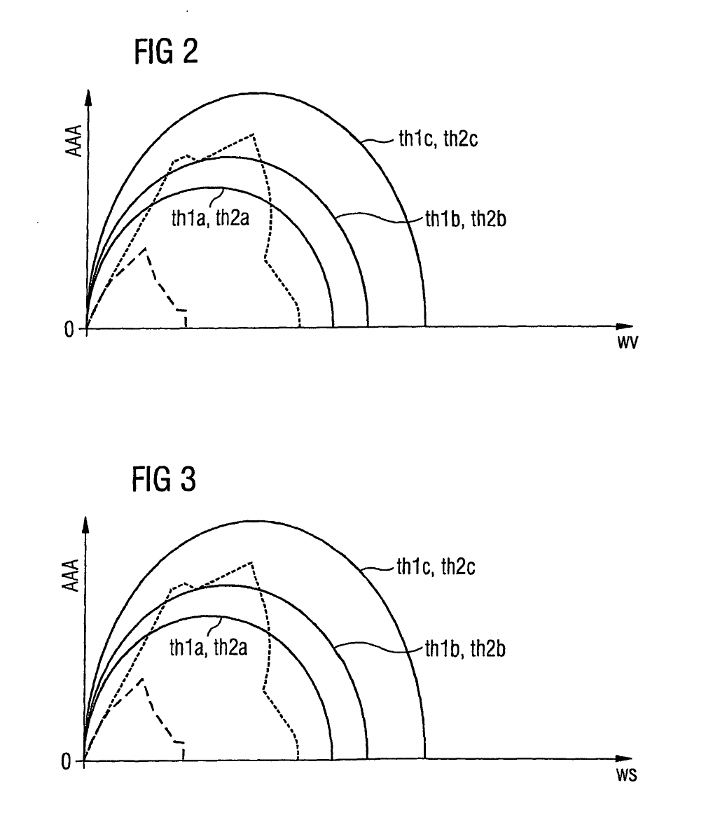

FIG. 2 a plot of the first crash variable AAA above a second crash variable wv for activation of an occupant protection means corresponding to a serious road traffic accident (dotted line) and a minor road traffic accident (dashed line) and, depending on this, shown as a solid line, a curve of the first and second threshold values for a first activation stage th2a and th2a, for a second activation stage th1b and th2b and a third activation stage th1c and th2c of a occupant protection means

FIG. 3 a plot corresponding to the plot shown in FIG. 2 with a second crash variable ws computed differently by comparison with FIG. 2 being entered on the horizontal axis,

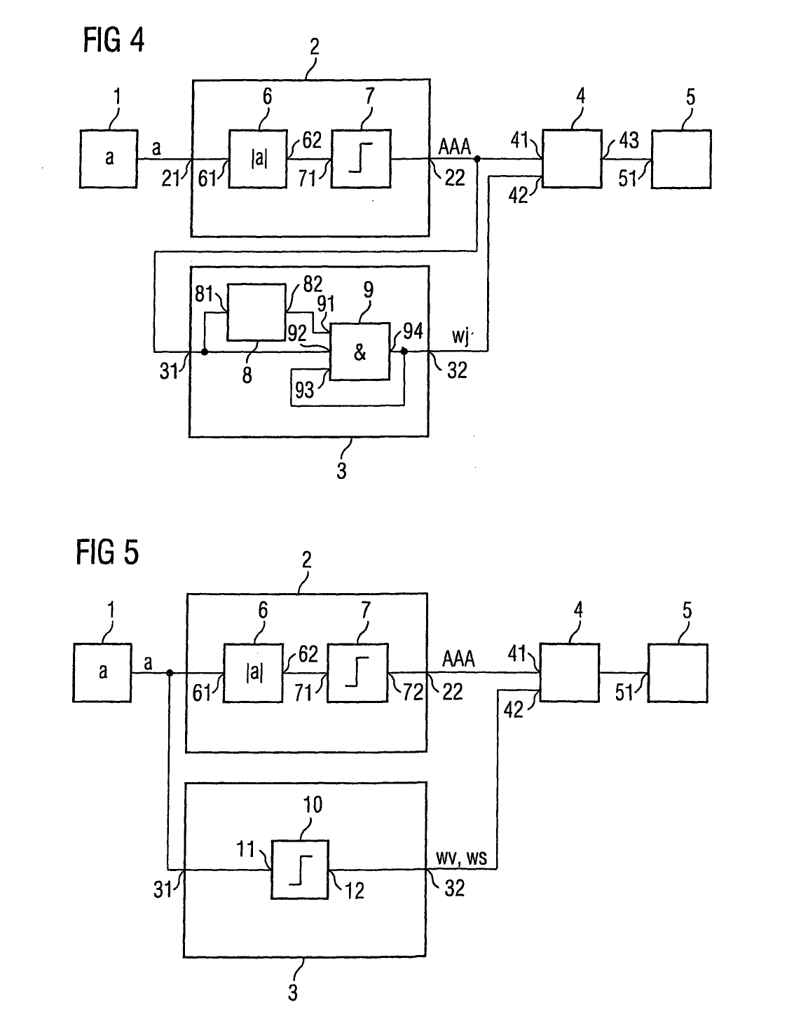

FIGS. 4 and 5 An inventive device for use in accordance with the inventive method.

FIG. 1 shows a plot of a first crash variable AAA on an ordinate and of a second crash variable wj on an abscissa of a schematic diagram, shown both for a minor road traffic accident (dashed line) and also for a serious road traffic accident (dotted line). The first characteristic value AAA plotted is, as already explained above, formed, according to the formula (1a) or (1) and therefore represents a time-limited integral value of the absolute amount of the signal of an acceleration sensor 1. This value gives an evaluation unit 4 decisive information about which accelerations on average act during of an observation period, specified in formula (1a) as time window T₂−T₁, on a vehicle occupant during a road traffic accident. In accordance with the different severities of the crash events depicted, higher values occur for the first crash variable AAA with serious accidents, shown as a dotted crash variable curve, than in the case of the minor accident, characterized by a curve shown as a dashed line

The values entered on the abscissa f the second crash variable wj are formed in accordance with the formula (2) already mentioned and thus represent an average change of the first crash variable AAA during a limited time window, specified in the formula (2) as time difference t_{n-b-1}−tₙ₋₁. This value accordingly represents a change of the average absolute amount of the acceleration signal a which provides information about the force acting on a vehicle occupant during the observation time frame. Accordingly an occurrence of higher values of the second crash variable wj can also be determined for the serious accident curve of the dotted line graph than for the dashed line crash variable curve.

Indicated by a solid line in each case is the curve of pairs of a first and second threshold value th1a and th2a, th1b and th2b, th1c and th2c respectively for the two crash variables AAA and wj. The curve of the lowest first-and second threshold values th1a, th2a is shown schematically in FIG. 1 as the smallest closed oval th1a, th2a. Only the dotted crash value curve goes outside the area which is enclosed by the smallest threshold value line th1a, th2a. This can be used by the evaluation unit to activate an occupant protection means immediately. Alternatively however merely a first stage of an occupant protection means which can be activated in a number of stages can be activated or a firing strategy defined in accordance with the severity of the accident can be selected.

In the case of the dashed-line crash variable curve the first threshold value line th1a, th2a of the first and second threshold values th1a and th2a is not exceeded. This curve is evidently a crash variable curve which should neither lead to an occupant protection means being fired nor indicates a crash situation in any way.

The next largest oval th1b, th2b plotted outside the smallest oval th1a, th2a represents the second threshold value line th1b, th2b of first and second threshold values th1b and th2b. This second threshold value line th1b, th2b too is exceeded by the crash variable curved plotted as a dotted line. Since this indicates a very serious accident the evaluation unit 4 could fire a second firing stage of the occupant protection means as well as a first stage, for example an air bag could be completely filled with gas in order to fill the intermediate area between mounting position of the airbag in the vehicle dashboard and the vehicle occupant as quickly as possible by an airbag as inflated as possible, in order to capture high accelerations experienced by the vehicle occupants during a road traffic accident.

A third threshold line th1c, th2c of a third pair of first and second threshold values th1c and th2c is plotted in the FIG. 1 as the third and largest oval th1c, th2c. Neither of the two crash variables wj and AAA exceed the respective associated threshold value th1c or th2c. Accordingly neither of the two crash variable curves (dotted line or dashed line) goes beyond the inner area of this largest oval th1c, th2c. A third activation stage of an occupant protection means which might possibly be fired would not be fired in this case. A criterion for a most serious possible accident would in this case not be reached, so that in this case the activation strategy of the occupant protection means would not have to be modified further.

It is to be noted that for the method in accordance with the invention it is of no significance which type of plotting its selected for the explanation of the inventive method provided here. The values of the second crash variable wj could also be plotted in FIG. 1 on the ordinate and the values of the first crash variable AAA on the abscissa. The decisive factor for the inventive method is merely an evaluation of a road traffic accident with the aid of the first crash variable AAA and of a second crash variable derived in comparison to the former in a different way from the crash signal a of the crash sensor 1 for example with one of the second crash variables wj, wv or ws disclosed here.

FIG. 2 essentially shows a graph plot corresponding to that of FIG. 1. However in this Figure a plot of the first crash variable AAA on the abscissa has been selected whereas the values of the second crash variable wv have been plotted on the ordinate.

The second crash variable wv is formed from a time-limited integral of the signed crash signal of a crash sensor 1 in accordance with one of the formulae (3a) or (3). Accordingly the second crash variable wv involves a speed value of the vehicle occupants during a restricted observation time window. For this reason no values of the second crash variable wv with different leading signs occur during the course of the crash variable curve for a serious road traffic accident (dotted line) and for a minor road traffic accident (dashed line), since a change in speed in such cases in general only occurs in one direction, namely in the direction of the vehicle deceleration.

If a value pair of plotted crash variables AAA and wv exceeds a threshold value line th1a/b/c, th2a/b/c, formed from first and second threshold values th1a and th2a, th1b and th2b as well as th1c and th2c, appropriately adapted measures for activating the connected occupant protection means are initiated in the evaluation unit 4, as has already been explained with reference to FIG. 1.

FIG. 3 shows a plot of the first crash variable AAA on the abscissa against values of the second crash variable ws on the ordinate. In this case the value of the second crash variable ws of FIG. 3 is formed in accordance with one of the formulae specified above (4a) or (4) and thus represents a double integral of the signed crash signal a of the crash sensor 1, which consequently specifies a measure for the preliminary displacement of a vehicle occupant as a result of the acceleration acting against them during a road traffic accident.

As in FIGS. 1 and 2, in FIG. 3 too exceeding one of the threshold lines th1a/b/c, th2a/b/c of the first and second threshold values th1a and th2a, th1b and th2b, th1c and th2c, causes the evaluation unit 4 to initiate a firing strategy for the occupation protection means adapted accordingly to the severity of the accident.

FIG. 4 shows an inventive device for use in an inventive method.

An acceleration sensor 1 outputs its acceleration signal a to the signal input 21 of a first acceleration signal processing unit 2, in which the acceleration signal a is fed directly to the signal input 61 of an absolute amount generator 6. There the sign is removed from the acceleration signal a, i.e. an absolute amount of the acceleration signal a is created.

The signal output 62 of the absolute amount generator 6 is connected to the signal input 71 of an integration unit 7 in which the absolute amount of the acceleration signal a is integrated during a restricted observation period and this is done in accordance with one of the previous formulae (1a) or (1). This value is output at the signal output 72 of the integration unit 7 as first crash variable AAA to the signal output 22 of the acceleration signal processing unit 2.

The signal output 22 of the acceleration signal processing unit 2 is connected to both the signal input 41 of the evaluation unit 4 and also to the signal input 31 of the second acceleration signal processing unit From there the crash variable AAA is fed to both the signal input 81 of a delay element 8 and also to a second signal input 92 of an addition/subtraction unit 9. The signal output 82 of the delay element 8 is connected to a first input 91 of the addition/subtraction 9.

The delay element 8 has the task of delaying values AAAᵢ of the first crash variable AAA by one clock period of an internal clock signal. The value AAAᵢ of the crash variable AAA without intermediate delay element 8 which is fed directly to the second input 92 of the addition/subtraction unit 9 is by contrast not delayed. In the addition/subtraction unit 9 a difference term AAAᵢ−AAAᵢ₋₁ of two chronologically consecutive values AAAᵢ, AAAᵢ₋₁ of the crash variable AAA is first formed.

At the same time the signal output 94 of the addition/subtraction unit 9 is connected to a third signal input 93 of the addition/subtraction unit. In normal operation of the inventive device a sum of the difference terms AAAᵢ−AAAᵢ₋₁ is available at the signal output 94 of the addition/subtraction unit 9.

The sum of the difference terms AAAᵢ−AAAᵢ₋₁ of two consecutive individual values AAAᵢ and AAAᵢ₋₁ in each case is forwarded to the signal output 32 of the second acceleration signal processing unit 3 as second crash variable wj and from there to the second signal input 42 of the evaluation unit 4.

In the evaluation unit 4 the two crash variables AAA and wj are evaluated, after which an evaluation unit 5 connected to the evaluation unit 4 is activated accordingly, which has already been described in detail above.

FIG. 5 shows a similar arrangement to FIG. 4 with the difference that an integration unit 10 is now arranged in the second acceleration signal processing unit 3, which is connected on its input side to signal input 31 and on its output side to signal output 32 of the second acceleration signal processing unit 3. Unlike the arrangement shown in FIG. 4, the acceleration signal a is fed directly to the signal input 31 of the acceleration signal processing unit.

The integration unit 10 creates a second crash variable wv at the signal output 32 of the acceleration signal processing unit 3 as a simple integral of the acceleration signal a which is formed in accordance with one of the above formulae (3a) or (3).

Alternatively the integration unit 10 is a double integration unit which on the one hand continuously integrates or adds the signed acceleration signal and furthermore integrates the result during a restricted time window (from T₁ to T₂) in accordance with the formula (4a) a second time, or in accordance with the application in a microcontroller calculates it by summation in accordance with the above formula (4). Accordingly the second crash variables wv and ws either represent a measure for the relative speed of an occupant during a road traffic accident (second crash variable wv) or a measure of their relative preliminary displacement (second crash variable ws).

As in FIG. 4, a second crash variable wv or ws is fed to the activation unit in which in conjunction with the first crash variable AAA if necessary an appropriate adaptation of the activation behavior of an occupant protection means is undertaken during the accident.

1-11. (canceled)

12. A method for controlling an occupant protection device in a motor vehicle, which comprises the steps of:
delivering, via a crash sensor, a crash signal;
deriving a first crash variable being an absolute value of the crash signal;
comparing the first crash variable with a first firing threshold;
comparing a second crash variable derived from the crash signal with a second firing threshold; and
controlling the occupant protection device in dependence on whether the first and second firing thresholds are exceeded.

13. The method according to claim 12, which further comprises deriving the first crash variable as an integral of the absolute value of the crash signal over a restricted period of time.

14. The method according to claim 12, which further comprises making the first crash variable available as a low-pass-filtered digital value.

15. The method according to claim 12, which further comprises forming the second crash variable from a sum of a number of difference terms of two chronologically consecutive digital values of the first crash variable in each case in accordance with:
$$wj ( {t}_{n} , b ) = {\sum }_{i = n - b}^{n} ( {AAA}_{i} ( {t}_{i} , b ) - {AAA}_{i - 1} ( {t}_{i - 1} , b ) ) . \qquad ( 2 )$$
where wj is the second crash variable.

16. The method according to claim 12, which further comprises deriving the second crash variable from an integral of the crash signal over a restricted period of time.

17. The method according to claim 12, which further comprises deriving the second crash variable from an integral of a third crash variable over a restricted period of time.

18. The method according to claim 12, which further comprises:
providing an acceleration sensor as the crash sensor; and
providing the crash signal as an acceleration signal.

19. The method according to claim 13, which further comprises:
deriving the first crash variable from a sum of chronologically consecutive digital values of the absolute value of the crash signal in accordance with:
$$AAA ( {t}_{n} , b ) = \frac{1}{b} {\sum }_{i = n - b}^{n} \vert {a}_{i} ( {t}_{i} ) \vert \cdot 1 ms , \qquad ( 1 )$$
where AAA is the first crash variable, tₙ is a time of determination of the first crash variable, b+1 is a number of sum terms, i is a sum index for a summation of i=n−b to n, aᵢ are the chronologically consecutive digital values of the crash signal, and ms stands for a physical unit milliseconds.

20. The method according to claim 16, which further comprises deriving the second crash variable from a sum of chronologically consecutive digital values of the crash signal in accordance with:
$$wv ( {t}_{n} , b ) = {\sum }_{i = n - b}^{n} {a}_{i} ( {t}_{i} ) \cdot 1 ms \qquad ( 3 )$$
where wv is the second crash variable and aᵢ is the digital values of the crash signal.

21. The method according to claim 17, which further comprises deriving the second crash variable from a sum of chronologically consecutive digital values of the third crash variable in accordance with
$$ws ( {t}_{n} , b ) = {\sum }_{i = n - b}^{n} Δ {v}_{i} ( {t}_{i} ) \cdot 1 ms = {\sum }_{i = n - b}^{n} {\sum }_{i = 0}^{n} {a}_{i} ( {t}_{i} ) \cdot 1 ms \cdot 1 ms , \qquad ( 4 )$$
where ws is the second crash variable, and Δv is the third crash variable resulting from a time integral of the crash signal being a sum of the consecutive digital values aᵢ of the crash signal in accordance with:
$$Δ v ( {t}_{n} ) = {\sum }_{i = 0}^{n} {a}_{i} ( {t}_{i} ) \cdot 1 ms . \qquad ( 5 )$$

22. A device for controlling an occupant protection device in a motor vehicle, the device comprising:
an acceleration sensor for capturing accelerations during a motor vehicle crash and generating an acceleration signal;
acceleration signal processing units coupled to said acceleration sensor for converting the acceleration signal generated by the acceleration sensor into a number of crash variables, said acceleration signal processing units each having a signal output;
an activation unit;
an evaluation unit having first and second signal inputs each respectfully connected to said signal output of each of said acceleration signal processing units, said evaluation unit evaluating the crash variables fed to it, said evaluation unit outputting a firing signal to said activation unit if at least two of the crash variables exceed a firing threshold in each case;
said acceleration signal processing units containing:
a first acceleration signal processing unit having a signal output and an absolute value generator with a first input receiving the acceleration signal and a first signal output outputting an absolute value of the acceleration signal to the signal output of said first acceleration signal processing unit, the absolute value of the acceleration signal being a first crash variable; and
a second acceleration signal processing unit having an input receiving the acceleration signal from said acceleration sensor and a signal output outputting a second crash variable derived from the acceleration signal, the second crash variable being fed to said second input of said evaluation unit.

23. The device according to claim 22, wherein said first acceleration signal processing unit has an integration unit connected downstream of said absolute value generator, said integration unit connected between said first signal output of said absolute value generator and said signal output of said first acceleration signal processing unit, at said signal output of said first acceleration signal processing unit the first crash variable is present as a time integral of the absolute value of the acceleration signal, in accordance with
$$AAA ( {t}_{n} , b ) = \frac{1}{b} {\sum }_{i = n - b}^{n} \vert {a}_{i} ( {t}_{i} ) \vert \cdot 1 ms , \qquad ( 1 )$$
whereby AAA is the first crash variable, a is the acceleration signal, tₙ is a time of determination of the first crash variable AAA, b+1 a number of sum terms, i is a sum index for summation of i=n−b to n, and ms stands for the physical unit milliseconds.

24. The device according to claim 22, wherein said second acceleration signal processing unit includes:
a delay element having a signal input receiving the first crash variable and a signal output; and
a logical addition/subtraction unit having a first signal input connected to said signal output of said delay element, a second signal input receiving the first crash variable, a third signal input, and a signal output connected both to said signal output of said second acceleration signal processing unit and also to said third signal input of said addition/subtraction unit, said signal output of said second acceleration signal processing unit outputting the second crash variable, said second accelerating processing unit forming the second crash variable as a sum of a number of difference terms of two chronologically consecutive digital values of the first crash variable in each case in accordance with
$$wj ( {t}_{n} , b ) = {\sum }_{i = n - b}^{n} ( {AAA}_{i} ( {t}_{i} , b ) - {AAA}_{i - 1} ( {t}_{i - 1} , b ) ) \qquad ( 2 )$$
where wj is the second crash variable.

25. The device according to claim 22, wherein said second acceleration signal processing unit includes a second integration unit for performing a time integration of any input signal received, said second integration unit having an input receiving the acceleration signal and an output connected to said signal output of said second acceleration signal processing unit, said second acceleration signal processing unit outputting the second crash variable embodied as a speed signal in accordance with:
$$wv ( {t}_{n} , b ) = {\sum }_{i = n - b}^{n} {a}_{i} ( {t}_{i} ) \cdot 1 ms \qquad ( 3 )$$
where wv is the second crash variable.

26. The device according to claim 22, wherein said second acceleration signal processing unit includes a second integration unit for performing a double time integration of input signals received, said second integration unit having an input receiving the acceleration signal and outputting the second crash variable embodied as a preliminary displacement signal in accordance with:
$$\begin{matrix}ws ( {t}_{n} , b ) = {\sum }_{i = n - b}^{n} Δ {v}_{i} ( {t}_{i} ) \cdot 1 ms = {\sum }_{i = n - b}^{n} {\sum }_{i = 0}^{n} {a}_{i} ( {t}_{i} ) \cdot 1 ms \cdot 1 ms \\ with & ( 4 ) \\ Δ v ( {t}_{n} ) = {\sum }_{i = 0}^{n} {a}_{i} ( {t}_{i} ) \cdot 1 ms , & ( 5 )\end{matrix}$$
so that in accordance with the double time integration of the acceleration signal by said second integration unit the second crash variable is used as a measure of a preliminary displacement experienced by a vehicle occupant relative to the motor vehicle.
